(19) United States
(12) Patent Application Publication
(10) Pub. No.: US 2023/0167591 A1
(43) Pub. Date: Jun. 1, 2023

(54) ELECTROSPUN NANOFIBROUS POLYMER MEMBRANE FOR USE IN AIR FILTRATION APPLICATIONS

(71) Applicant: Matregenix, Inc., Irvine, CA (US)

(72) Inventors: Sherif Soliman, Irvine, CA (US); Feng Guo, Irvine, CA (US)

(73) Assignee: Matregenix, Inc., Irvine, CA (US)

(21) Appl. No.: 17/937,445

(22) Filed: Sep. 30, 2022

Related U.S. Application Data
(63) Continuation-in-part of application No. PCT/US2021/025285, filed on Mar. 31, 2021.
(60) Provisional application No. 63/116,799, filed on Nov. 20, 2020.
(60) Provisional application No. 63/002,435, filed on Mar. 31, 2020.
(60) Provisional application No. 63/267,877, filed on Feb. 11, 2022.
(60) Provisional application No. 63/262,246, filed on Oct. 7, 2021.

(51) Int. Cl. D04H 1/728; B82Y 30/00; B01D 71/34; B01D 39/16; B01D 69/02; D04H 1/4318; B01D 71/54; B01D 69/12; B01D 67/00; B01D 71/02; B01D 53/02

(52) U.S. Cl. CPC D04H 1/728; B01D 39/1623; B01D 53/02; B01D 67/0069; B01D 67/0088; B01D 69/02; B01D 69/1216; B01D 69/1218; B01D 71/021; B01D 71/34; B01D 71/54; B82Y 30/00; D04H 1/4318; B01D 2239/025; B01D 2253/25; B01D 2253/102; B01D 2253/202; B01D 2253/311; B01D 2257/504; B01D 2257/556; B01D 2258/06; B01D 2323/15; B01D 2323/39; D10B 2321/042; D10B 2401/10

(57) ABSTRACT

An electrospun polymer nanofibrous membrane that provides high filtering efficiency and excellent porosity is disclosed herein. The membrane may be treated with one or more antimicrobial or antiviral agents. The treatment may preferably be a coating of one or more antiviral agents on the surface of the membrane. Alternatively, one or more antiviral agents may be impregnated into the membrane. The membrane may additionally or alternatively be impregnated with one or more metal-organic frameworks (MOFs). The membrane has a high filtering efficiency and sufficient porosity to provide breathability characteristics. In some embodiments, the membrane is suitable for use in making facemasks and respirators that are highly resistant to infectious pathogens and/or other small particulates. In some embodiments, the membrane is suitable for use in HVAC applications. In some embodiments, the membrane is suitable for use in removal of VOCs and CO₂ in conjunction with a carbon nanofiber membrane.

### CROSS-REFERENCE TO RELATED APPLICATIONS

This application is a continuation-in-part of PCT Pat. Application No. PCT/US2021/025285, filed on Mar. 31, 2021, which claims the benefit of U.S. Provisional Pat. Application Serial Nos. 63/002,435, filed on Mar. 31, 2020, and 63/116,799, filed on Nov. 20, 2020; and this application also claims the benefit of U.S. Provisional Pat. Application Serial Nos. 63/262,246, filed on Oct. 7, 2021, and 63/267,877, filed on Feb. 11, 2022; the disclosures of which are hereby incorporated in their entireties herein by reference.

### BACKGROUND

### Field of the Invention

The present disclosure relates to materials for use in air filtration applications.

### Description of the Related Art

Clean air is generally deemed a basic requirement for promoting human health and well-being. Air pollution—including particulate matter (PM) and chemical and biological contaminants—poses a significant threat to health worldwide. The World Health Organization reported that air pollution led to 4.2 million premature deaths worldwide in 2016. See World Health Organization, “Ambient (Outdoor) Air Pollution,” 2021 (available at: https://www.who.int/en/news-room/fact-sheets/detail/ambient-(outdoor)-air-quality-and-health). Poor air quality, including hazardous pollutants and pathogens, increases the risk of a variety of diseases, including respiratory infections, cardiovascular disease, chronic obstructive pulmonary disease, and various types of cancer. Id.

The use of air filters to reduce human exposure to hazardous pollutants and pathogens is highly desirable. However, currently available commercial air filters are frequently composed of multiple layers of thick fibrous materials to achieve high filtration efficiency, which results in significant airflow resistance. See, e.g., Wang, C., et al. “Silk Nanofibers as High Efficient and Lightweight Air Filter,” Nano Res. 2016, 9, 2590-97. There has been an interest in the use of nanofibers in air filtration to generate high efficiency, low airflow resistance, lightweight air filters. See, e.g., Wang, C.-s., et al. “Removal of Nanoparticles from Gas Streams by Fibrous Filters: A Review,” Ind. Eng. Chem. Res. 2013, 52, 5-17; Peng, L., et al. “Air Filtration in the Free Molecular Flow Regime: A Review of High-Efficiency Particulate Air Filters Based on Carbon Nanotubes,” Small, 2014, 10, 4543-61. In addition, due to the large surface area of nanofiber surfaces, it is possible to modify nanofiber surfaces to achieve multi-functionality.

Air filtration is an important tool for enhancing indoor air quality. Thus, air filters incorporating nanofibers may be very useful in HVAC applications.

It is also desirable to remove volatile organic compounds (VOCs) in air filtration applications, as various VOCs have a number of well-established detrimental health effects. On account of various shortcoming of conventional methods of removing VOCs from indoor air, a number of recent efforts have focused on the use of photocatalytic degradation of VOCs. See, e.g., Singh, P., et al. “A Review on Biodegradation and Photocatalytic Degradation of Organic Pollutants: A Bibliometric and Comparative Analysis,” J. Clean. Prod. 2018, 196, 1669-80; Malayeri, M., et al. “Modeling of Volatile Organic Compounds Degradation by Photocatalytic Oxidation Reactor in Indoor Air: A Review,” Build. Environ. 2019, 154, 309-23.

Photodegradation of VOCs may generate carbon dioxide (CO₂). Global climate change caused by the emission of massive amounts of greenhouse gases, including carbon dioxide (CO₂), is causing alarming threats to the environment and public health. Thus, CO₂ capture technologies have drawn tremendous attention. See, e.g., Qi, G., et al. “High Efficiency Nanocomposite Sorbents for CO₂ Capture Based on Amine-Functionalized Mesoporous Capsules,” Energy Environ. Sci. 2011, 4, 444-52; Zainab, G., et al. “Electrospun Carbon Nanofibers with Multi-Aperture/Opening Porous Hierarchical Structure for Efficient CO₂ Adsorption,” J. Colloid Interface Sci. 2020, 561, 659-67; Wang, X., et al. “Polyetheramine Improves the CO₂ Adsorption Behavior of Tetraethylenepentamine-Functionalized Sorbents,” Chem. Eng. J. 2019, 364, 475-84. Coupling photodegradation processes with CO₂ removal will thus reduce the impact of photocatalytic VOC removal processes on global climate change.

In addition, it may be desirable in various applications to functionally modify air filters to facilitate pathogen removal. Infectious respiratory pathogens are typically transmitted by droplet, aerosol, or airborne transmission of particles expelled from the respiratory tract of an infected person by coughing or sneezing, or in some cases by simple exhalation. To prevent this form of transmission, air filters may be used both to remove pathogens from ambient air and to protect individuals from inhaling any pathogens present in ambient air.

For applications focused on protecting individuals from pathogens present in ambient air, facemasks and respirators have been developed that either mechanically intercept the infectious particles or that disarm the infectious particles using a variety of mechanisms. Therefore, many research and development efforts have been made to enhance the filtering efficiency of facemasks and respirators.

The COVID-19 pandemic has highlighted the need for functional protective textiles for a variety of applications. Functional protective textiles are particularly important for use in protective clothing for medical professionals, field workers, and soldiers. See, e.g., Zhu, Q., et al. “AQC Functionalized CNCs/PVA-co-PE Composite Nanofibrous Membrane with Flower-Like Microstructures for Photo-Induced Multi-Functional Protective Clothing,” Cellulose, 2018, 25, 4819-30, doi: 10.1007/s10570-018-1881-5; Liu, Y., et al. “UV-Crosslinked Solution Blown PVDF Nanofiber Mats for Protective Applications,” Fibers Polym. 2020, 21, 489-97, doi: 10.1007/s12221-020-9666-5.

To limit dermal exposure to airborne solid particles, health and safety regulatory agencies have published good practice guidelines, and wearing personal protective equipment (PPE) has been recommended to minimize exposure to a variety of hazards. Chemical and biological protective clothing (CBPC) are widely used and are considered the most economical among PPE options. For airborne nanomaterials, type 5 CBPC is considered the last line of defense against such dangers, as it provides full body protection against airborne solid particulates according to the ISO 13982-1 and ISO 13982-2 standards. See International Organization for Standardization (ISO) 13982-1:2004; International Organization for Standardization (ISO) 13982-2:2004.

Nonwoven and woven materials commonly used as the base for type 5 CBPC have several disadvantages, such as poor permeability and filterability. See, e.g., Liu, Y., et al., supra; Wingert, L., et al. “Filtering Performances of 20 Protective Fabrics Against Solid Aerosols,” J. Occup. Environ. Hyg. 2019, 16, 592-606.

Current commercially available facemasks and respirators either do not have adequate filtering efficiency to intercept the infectious particles or have insufficient air permeability to allow frequent and convenient use. Lee, S., et al. “Reusable Polybenzimidazole Nanofiber Membrane Filter for Highly Breathable PM_{2.5} Dust Proof Mask,” ACS Appl. Mater. Interfaces, 2019, 11, 2750-57, doi:10.1021/acsami.8b19741. Moreover, the recent COVID-19 pandemic has increased interest in antiviral membrane development for facemasks and respirators which will exterminate pathogens contacting the facemask or respirator. This will prevent infectious particles to be transferred to another surface by inadvertent contact of the mask with other surfaces or by the wearer touching the exterior surface of the mask by hand.

Numerous antiviral agents are known that may be suitable for use in coatings or that may otherwise be integrated into personal protective equipment. See, e.g., Tran, D.N., et al. “Silver Nanoparticles as Potential Antiviral Agents against African Swine Fever Virus,” Mater. Res. Express, 2020, 6(12), doi: 10.1088/2053-1591/ab6ad8; Moreno, M.A., et al. “Active Properties of Edible Marine Polysaccharide-Based Coatings Containing Larrea nitida Polyphenols Enriched Extract,” Food Hydrocoll. 2020, 102, 105595, doi: 10.1016/j.foodhyd.2019.105595; Husen, A. “Natural Product-Based Fabrication of Zinc-Oxide Nanoparticles and Their Applications,” In Nanomaterials and Plant Potential, 2019, 193-219, Springer; Cheng, C., et al. “Functional Graphene Nanomaterials Based Architectures: Biointeractions, Fabrications, and Emerging Biological Applications,” Chem. Rev. 2017, 117, 1826-1914; Zhang, D.-h., et al. “In Silico Screening of Chinese Herbal Medicines with the Potential to Directly Inhibit 2019 Novel Coronavirus,” J. Integr. Med. 2020, 18, 152-8, doi: 10.1016/j.joim.2020.02.005; U.S. Pat. Nos. 9,963,611 and 8,678,002.

Widespread use of facemasks, such as during the COVID-19 pandemic, has also highlighted a need for transparent materials for producing facemasks and other personal protective equipment. For example, children who are on the autism spectrum, elderly persons with limited hearing, and deaf-mute persons may have difficulty with communication and social interactions which do not allow such persons to observe facial expressions and would thereby significantly benefit from widespread use of transparent facemasks. Transparent facemasks would also be compatible with facial recognition technologies, such as technologies used for identity authentication. The use of nanofiber membranes also offers promise in addressing this need. See, e.g., Wang, C., et al. “Highly Transparent Nanofibrous Membranes Used as Transparent Masks for Efficient PM_{0.3} Removal,” ACS Nano, 2022, 16(1), 119-28; Xiao, Y., et al. “Preparation and Applications of Electrospun Optically Transparent Fibrous Membrane,” Polymers, 2021, 13(4), 506.

Various techniques for producing nanofiber membranes are known, including electrospinning, phase inversion, interfacial polymerization, stretching, and track-etching. Electrospinning is a very useful technique that provides efficiency and uniformity of pore size. See, e.g., Ray, S.S., et al. “A Comprehensive Review: Electrospinning Technique for Fabrication and Surface Modification of Membranes for Water Treatment Application,” RSC Adv. 2016, 6(88), 85495-85514, doi: 10.1039/C6RA14952A. Electrospinning is a process that uses an electric field to generate continuous fibers on a micrometer or nanometer scale. Electrospinning enables direct control of the microstructure of a scaffold, including characteristics such as the fiber diameter, orientation, pore size, and porosity.

Electrospun nanofibers have a wide range of applications. These include antibacterial food packaging, biomedical applications, and environmental applications. See, e.g., Lin, L., et al. “Cold Plasma Treated Thyme Essential Oil/Silk Fibroin Nanofibers against Salmonella Typhimurium in Poultry Meat,” Food Packag. Shelf Life, 2019, 21, 100337; Zhu, Y., et al. “A Novel Polyethylene Oxide/Dendrobium officinale Nanofiber: Preparation, Characterization and Application in Pork Packaging,” Food Packag. Shelf Life, 2019, 21, 100329; Surendhiran, D., et al. “Encapsulation of Phlorotannin in Alginate/PEO Blended Nanofibers to Preserve Chicken Meat from Salmonella Contaminations,” Food Packag. Shelf Life, 2019, 21, 100346; Khan, M.Q., et al. “The Development of Nanofiber Tubes Based on Nanocomposites of Polyvinylpyrrolidone Incorporated Gold Nanoparticles as Scaffolds for Neuroscience Application in Axons,” Text. Res. J. 2019, 89, 2713-20, doi: 10.1177/0040517518801185; Ullah, S., et al. “Antibacterial Properties of In Situ and Surface Functionalized Impregnation of Silver Sulfadiazine in Polyacrylonitrile Nanofiber Mats,” Int. J. Nanomedicine, 2019, 14, 2693-2703, doi: 10.2147/IJN.S197665; Khan, M.Q., et al. “Fabrication of Antibacterial Electrospun Cellulose Acetate/Silver-Sulfadiazine Nanofibers Composites for Wound Dressings Applications,” Polym. Test. 2019, 74, 39-44. Doi: 10.1016/j.polymertesting.2018.12.015; Ray, S.S., et al., supra.

Electrospun nanofiber textiles have been considered promising candidates for CBPC. See, e.g., Lee, S., et al. “Transport Properties of Layered Fabric Systems Based on Electrospun Nanofibers,” Fibers Polym. 2007, 8, 501-06; Bagherzadeh, R., et al. “Transport Properties of Multi-Layer Fabric Based on Electrospun Nanofiber Mats as a Breathable Barrier Textile Material,” Text. Res. J. 2012, 82, 70-76.

Electrospun polymeric nanofibers may exhibit very high external surface area, excellent water vapor transport properties, and good mechanical strength. See, e.g., Huang, Z., et al. “A Review on Polymer Nanofibers by Electrospinning and Their Applications in Nanocomposites,” Compos. Sci. Technol. 2003, 63, 2223-53.

Fabrication of textiles from electrospun polymeric nanofibers generates ultrathin, lightweight, and high tensile strength textiles. See, e.g., Lee, S., et al., supra; Dhineshbabu, N. R., et al. “Electrospun MgO/Nylon 6 Hybrid Nanofibers for Protective Clothing,” Nano-Micro Lett. 2014, 6, 46-54; Han, Y., et al. “Reactivity and Reusability of Immobilized Zinc Oxide Nanoparticles in Fibers on Methyl Parathion Decontamination,” Text. Res. J. 2013, 86, 339-49.

Electrostatic attraction causes small particles to be attracted to nanofibers. However, such electrostatic attraction tends to wear off relatively quickly. Integrating principles of electrostatic interaction with a triboelectric nanogenerator (TENG) may be used to harvest mechanical energy from routine activities (e.g., respiration, talking, making facial expressions) and thereby generate charges on nanofiber filter media and prolong the duration of electrostatic attractions. This prolongs the useful life of filters that rely at least in part on electrostatic attractions for filtration.

Peng, et al. disclose a breathable, biodegradable, antibacterial, and self-powered electronic skin by sandwiching a silver nanowire electrode between a polylactic-co-glycolic acid (PLGA) triboelectric layer and a polyvinyl alcohol (PVA) substrate. Peng, X., et al. “A Breathable, Biodegradable, Antibacterial, and Self-Powered Electronic Skin Based on All-Nanofiber Triboelectric Nanogenerators,” Sci. Adv. 2020, 6(26), eaba9624.

Sun, et al. disclose an all-fiber breathable and waterproof wearable device with a multilayer structure consisting of a PA66/carbon nanotubes nanofiber layer, a poly (vinylidene fluoride) (PVDF) layer, and a conductive fabric layer. Sun, N., et al. “Waterproof, Breathable and Washable Triboelectric Nanogenerator Based on Electrospun Nanofiber Films for Wearable Electronics,” Nano Energy, 2021, 90, 106639.

Jiang, et al. disclose electrospinning nanofibers to develop a multifunctional all-nanofiber-based TENG with UV-protective, water-repellent, antibacterial, self-cleaning, and self-powered properties. Jiang, Y., et al. “UV-Protective, Self-Cleaning, and Antibacterial Nanofiber-Based Triboelectric Nanogenerators for Self-Powered Human Motion Monitoring,” ACS Appl. Mater. Interfaces, 2021, 13(9), 11205-14.

Chen, et al. disclose functionalized nanofiber mats generated by integrating nucleophilic oxime moieties through electrospinning of polyacrylamidoxime (PAAO) and PAN. These functionalized nanofiber mas exhibited a substantial ability to hydrolyze chemical nerve agents. Chen, L., et al. “Multifunctional Electrospun Fabrics via Layer-by-Layer Electrostatic Assembly for Chemical and Biological Protection,” Chem. Mater. 2010, 22, 1429-36.

Choi, et al. disclose fabricated polyurethane nanofibers functionalized by N-chloro hydantoin (NCH-PU). These nanofibers successfully decontaminated a simulant for V-type nerve gas (demeton-S-methyl). Choi, J., et al. “N-Chloro Hydantoin Functionalized Polyurethane Fibers Toward Protective Cloth Against Chemical Warfare Agents,” Polymer, 2018, 138, 146-55.

Various metal nanoparticles integrated nanofibers have been disclosed that have been proposed for use in protective clothing and face masks for shielding against harmful chemicals and biological agents. See, e.g., Ramaseshan, R., et al. “Zinc Titanate Nanofibers for the Detoxification of Chemical Warfare Simulants, J. Am. Ceram. Soc. 2007, 90, 1836-42.

Lee, et al. disclose functional PAN nanofiber webs to protect users from a simulant of a chemical warfare agent (CWA). Lee, J., et al. “Preparation of Non-Woven Nanofiber Webs for Detoxification of Nerve Gases,” Polymer, 2019, 179, 121664.

Zhao, et al. disclose metal-organic frameworks (MOFs) integrated into polyamide-6 nanofibers. The MOF-nanofiber composites exhibited extraordinary reactivity for detoxifying CWAs. Zhao, J., et al. “Ultra-Fast Degradation of Chemical Warfare Agents Using MOF-Nanofiber Kebabs,” Angew. Chem. Int. Ed. 2016, 55, 13224-28.

Zhao, et al. disclose a step-by-step dip-coating and heat curing method of fabricating fluorine-free, efficient, and biodegradable waterproof and breathable membranes. Zhao, J., et al. “Fluorine-Free Waterborne Coating for Environmentally Friendly, Robustly Water-Resistant, and Highly Breathable Fibrous Textiles,” ACS Nano, 2020, 14(1), 1045-54.

Zhang, et al. disclose a moisture pump with multilayer wood-like cellular networks and interconnected open channels based on an electrospun nanofibrous membrane for solar-driven continuous indoor dehumidification. Zhang, Y., et al., “Super Hygroscopic Nanofibrous Membrane-Based Moisture Pump for Solar-Driven Indoor Dehumidification,” Nat. Commun. 2020, 11(1), 3302.

On account of challenges related to scale-up of nanofiber production processes, nanofiber-based air filters are still currently rare. Thus, it remains a need to develop a scalable nanofiber platform to produce nanofiber membranes for use in air filtration applications.

### SUMMARY

An electrospun polymer nanofibrous membrane that provides high filtering efficiency and excellent porosity is disclosed herein.

The membrane may be treated with one or more antimicrobial or antiviral agents. In some embodiments, the membrane may be treated with an antiviral agent selected from the group consisting of graphene, nanoparticles, nanocomposites, multivalent metallic ions, and medicinal or other extracts from natural products. The treatment may preferably be a coating of one or more antiviral agents on the surface of the membrane. Alternatively, one or more antiviral agents may be impregnated into the nanofibrous membrane.

The membrane may additionally or alternatively be impregnated with one or more metal-organic frameworks (MOFs). The one or more MOFs may, for example, be one or more zirconium MOFs. The MOFs may provide filtration of chemical warfare agents (CWAs) and other toxic chemical agents and, in some embodiments, may also provide additional or alternate filtration of small particulates and pathogens.

The membrane may additionally or alternatively incorporate one or more photocatalytic agents for the removal of volatile organic compounds (VOCs).

The disclosed membrane may preferably have a high filtering efficiency.

In some embodiments, the porosity of the disclosed membrane may be sufficient to provide breathability characteristics suitable for use as a facemask or respirator. The disclosed membrane is suitable for use in making facemasks and respirators that are highly resistant to infectious pathogens and/or other small particulates.

In some embodiments, the disclosed membrane may be suitable for use in making air filters for use in indoor air filtration applications, such as use in air filters for HVAC systems.

In some embodiments, the disclosed membrane may be used in conjunction with a separate membrane that facilitates removal of carbon dioxide, such as a carbon nanofiber membrane.

In some embodiments, the disclosed membrane may be substantially transparent.

### BRIEF DESCRIPTION OF THE DRAWINGS

FIG. 1 shows representative scanning electron microscopy (SEM) images of embodiments of the disclosed nanofibrous polymer membranes.

FIG. 2 shows fiber diameter measurements and distribution for representative samples of an embodiment of the disclosed nanofibrous polymer membrane.

FIG. 3 shows pore size distribution for representative samples of an embodiment of the disclosed nanofibrous polymer membrane as determined by mercury porosimeter analysis.

FIG. 4 shows average porosity and the distribution of mean porosity for representative samples of an embodiment of the disclosed nanofibrous polymer membrane.

FIG. 5 shows mechanical tensile strength test results for representative samples of an embodiment of the disclosed nanofibrous polymer membrane.

FIG. 6 shows filtration efficiency test results for representative samples of an embodiment of the disclosed nanofibrous polymer membrane.

FIG. 7 shows latex filtration test results for representative samples of an embodiment of the disclosed nanofibrous polymer membrane.

FIG. 8 shows viral filtration efficiency test results for representative samples of an embodiment of the disclosed nanofibrous polymer membrane.

FIG. 9 shows bacteria filtration efficiency test results for representative samples of an embodiment of the disclosed nanofibrous polymer membrane.

FIG. 10 shows flammability test results for a representative sample of an embodiment of the disclosed nanofibrous polymer membrane.

FIG. 11 shows antiviral properties test results for representative samples of an embodiment of the disclosed nanofibrous polymer membrane.

FIG. 12 shows antibacterial properties test results for representative samples of an embodiment of the disclosed nanofibrous polymer membrane.

FIG. 13 shows how filtration efficiency is affected by the flow rate of aerosols through the membrane.

FIG. 14 shows how the pressure drop across the membrane is affected by the flow rate of aerosols through the membrane.

FIG. 15 shows an embodiment of a system for removing volatile organic compounds and carbon dioxide.

FIG. 16 shows the basic repeat units of rectangular, hexagonal, and trihexagonal opening patterns for mesh substrates.

FIG. 17 shows a schematic representation of a flexible, breathable, and antimicrobial facemask based on an all-nanofiber TENG (NF-TENG) platform.

### DETAILED DESCRIPTION

An electrospun polymer nanofibrous membrane that provides high filtering efficiency and excellent porosity is disclosed herein.

The membrane may be treated with one or more antimicrobial or antiviral agents. In some embodiments, the membrane may be treated with an antiviral agent selected from the group consisting of graphene, nanoparticles, nanocomposites, multivalent metallic ions, and medicinal or other extracts from natural products. The treatment may preferably be a coating of one or more antiviral agents on the surface of the membrane. Alternatively, one or more antiviral agents may be impregnated into the nanofibrous membrane.

The membrane may additionally or alternatively be impregnated with one or more metal-organic frameworks (MOFs). The one or more MOFs may, for example, be one or more zirconium MOFs. The MOFs may provide filtration of chemical warfare agents (CWAs) and other toxic chemical agents and, in some embodiments, may also provide additional or alternate filtration of small particulates and pathogens.

The membrane may additionally or alternatively incorporate one or more photocatalytic agents for the removal of volatile organic compounds (VOCs).

The disclosed membrane may preferably have a high filtering efficiency.

In some embodiments, the porosity of the disclosed membrane may be sufficient to provide breathability characteristics suitable for use as a facemask or respirator. The disclosed membrane is suitable for use in making facemasks and respirators that are highly resistant to infectious pathogens and/or other small particulates.

In some embodiments, the disclosed membrane may be suitable for use in making air filters for use in indoor air filtration applications, such as use in air filters for HVAC systems.

In some embodiments, the disclosed membrane may be used in conjunction with a separate membrane that facilitates removal of carbon dioxide, such as a carbon nanofiber membrane.

The disclosed membrane may preferably have a filtering efficiency of at least 95%, more preferably at least 98%, even more preferably at least 99%, and most preferably at least 99.5%.

In some embodiments, the disclosed membrane may be substantially transparent. The transparency may preferably be at least 80%.

The disclosed membrane may preferably be capable of intercepting and exterminating infectious pathogens on its surfaces.

In some preferred embodiments, the disclosed membrane is non-flammable.

The disclosed membrane may be suitable for the production of non-flammable high-performance textiles.

In some preferred embodiments, the disclosed membrane is ultrathin and lightweight.

In some preferred embodiments, the disclosed membrane does not degrade upon exposure to water or selected organic solvents such as ethanol or acetone. Thus, products made using the membrane may be washed and reused.

In some embodiments, the nanofibrous polymer membrane may be made from polyvinylidene fluoride (PVDF). In some alternate embodiments, the nanofibrous polymer membrane may be made from one or more Tecophilic™ thermoplastic polyurethanes (TPUs). In other alternate embodiments, the nanofibrous polymer membrane may be made from one or more polycaprolactams. In some additional alternate embodiments, the nanofibrous polymer membrane may be made from polyvinylpyrrolidone (PVP). In some additional alternate embodiments, the nanofibrous polymer membrane may be made from poly(vinylidene fluoride-co-hexafluoro propylene) (PVDF-HFP). In some additional alternate embodiments, the nanofibrous polymer membrane may be made from polylactic acid (PLA). In some other alternate embodiments, the nanofibrous polymer membrane may be made from a blend of two or more of polyvinylidene fluoride, one or more Tecophilic™ thermoplastic polyurethanes, one or more polycaprolactams, polyvinylpyrrolidone, poly(vinylidene fluoride-co-hexafluoro propylene), and polylactic acid.

The nanofibrous polymer membrane may be made using electrospinning techniques. A polymer is dissolved in a solvent prior to electrospinning. In some embodiments, the solvent may preferably be selected from the group consisting of dimethylformamide (DMF), dimethylacetamide (DMA), ethanol, hexafluoroisopropanol (HFIP), acetone, ethyl acetate, dichloromethane (DCM), formic acid, water, or a combination thereof. In some preferred embodiments, the solvent may be hexafluoroisopropanol (HFIP).

In some embodiments, a surfactant may be added to the polymer solution. Adding a surfactant to the polymer solution may promote a smaller fiber diameter and thus yield a membrane which has a smaller pore size and thus higher filtration efficiency. In some preferred embodiments, the surfactant may be one or more surfactants selected from the group consisting of cetrimonium bromide (CTAB), lauramidopropyl betaine (LAPB), and alpha olefin sulfonate (AOS).

In some embodiments, a salt or salt solution may be added to the polymer solution. Adding a salt or salt solution to the polymer solution may promote formation of thinner and more uniform fibers, may reduce bead formation, and/or may increase branching within the fibers. By increasing charge density and conductivity, the presence of salts in the polymer solution promotes elongation of the spinning jet, which leads to the generation of thinner fibers. In some preferred embodiments, the salt or salt solution may be one or more salts or salt solutions selected from the group consisting of alkali metal halides, substituted or unsubstituted ammonium halides, and phosphate-buffered saline (PBS). In some more preferred embodiments, the salt or salt solution may be one or more salts selected from the group consisting of sodium chloride (NaCl), lithium chloride (LiCl), and potassium chloride (KCl).

The nanofibrous polymer membrane may be a single layer membrane or may alternatively be an integrated multi-layer membrane. In some embodiments, the membrane may be composed of multiple integrated layers with distinguishable microstructure characteristics. A membrane that is composed of multiple integrated layers may provide enhanced filtration efficiency and low airflow resistance. Low airflow resistance corresponds to high breathability in applications where this is relevant. The enhanced filtration efficiency of an integrated multi-layer membrane may result from superior barrier protection against small pathogen particles and small diameter particulate matter.

In some embodiments, the integrated multi-layer membrane is composed of two layers with different pore sizes. In some alternate embodiments, the integrated multi-layer membrane is composed of three layers with two layers of equal pore size separated by a layer with a different pore size. The pore size may preferably be between 1 and 20 µm for the layer(s) with smaller pore size and between 20 and 200 µm for the layer(s) with larger pore size.

In embodiments with three layers having two layers of equal pore size separated by a layer with a different pore size, the layers of equal size may preferably have a larger pore size and the layer in between these two layers may preferably have a smaller pore size. This configuration decreases the likelihood of delamination and also decreases the pressure drop that is generated as a gas passes through the multi-layer membrane, which corresponds to increased breathability, without appreciably reducing the filtration efficiency of the membrane.

In some other alternate embodiments, the integrated multi-layer membrane is composed of three layers with three different pore sizes.

The pore size of the layers in integrated multi-layer membranes may be adjusted by adjusting the viscosity of the polymer solution and the electrospinning process conditions. Electrospinning process conditions may be adjusted to further stabilize the spinning jet used in the electrospinning setup. Solutions with lower viscosity will typically generate smaller pore size layers, and solutions with higher viscosity will typically generate larger pore size layers.

In some embodiments, the mechanical integrity and binding forces between layers of the membrane may be enhanced by electrospraying short fibers prior to electrospinning the subsequent layer. In some other embodiments, the mechanical integrity and binding forces between layers of the membrane may be enhanced by electrospinning wet fibers by decreasing the screen distance to generate a “tacky surface” prior to electrospinning the subsequent layer.

In some embodiments, the disclosed nanofibrous polymer membrane may be laminated onto a textile material. Alternatively, the nanofibers may be directly electrospun on nonwoven fabrics such as polyethylene terephthalate (PET), polypropylene (PP), polyamides such as PA6, PET copolymers, and spunbond Bico materials. Transparent nonwoven fabrics may be used for applications where transparency of the electrospun nanofibrous polymer membranes is desirable. The use of PET copolymers or spunbond Bico materials results in enhanced adhesion between the nanofibers and textile, which thereby reduces peeling.

In some embodiments, the disclosed nanofibrous polymer membrane is directly electrospun onto a mesh substrate. The mesh substrate may have an opening pattern specifically designed to be suitable for electrospinning nanofibers thereon. The opening pattern of the mesh substrate may, for example, be a rectangular, hexagonal, or trihexagonal opening pattern, as shown in FIG. 16. Electrospinning onto a mesh substrate may allow the production of a transparent or substantially transparent nanofibrous polymer membrane.

In some embodiments, the disclosed nanofibrous polymer membrane is triboelectrically charged using a triboelectric nanogenerator (TENG). This yields a membrane that is self-charging. In some embodiments, the nanofibrous tribo-negative layer may be composed of polyvinylidene fluoride (PVDF). In some embodiments, the nanofibrous tribo-positive layer may be composed of polyamide (PA66) nanofibers.

In some embodiments, the conductive electrode layer may be composed of a polypyrrole-coated nanofibrous membrane. In some alternate embodiments, the conductive electrode layer may be composed of silver nanofibers. In some other alternate embodiments, the conductive electrode layer may be composed of conductive fabrics

In some embodiments, a cellulose-based adhesive is applied to an electrospinning substrate prior to electrospinning to enhance the mechanical integrity of the nanofibrous membrane layers under high air flow conditions.

In some embodiments, a polyvinylacetate (PVAc) layer is electrospun onto an electrospinning substrate at the same time as electrospinning of the target polymer.

The disclosed nanofibrous polymer membrane may be treated with an anti-pathogenic agent such as an antiviral agent selected from the group consisting of graphene, nanoparticles, nanocomposites, multivalent metallic ions, and medicinal or other extracts from natural products. The graphene may be functionalized or non-functionalized. The nanoparticles may preferably be metal nanoparticles such as silver nanoparticles or zinc nanoparticles. The nanocomposites may preferably be silver-doped titanium dioxide nanomaterials. The multivalent metallic ions may preferably be metal ions such as Cu²⁺ or Zn²⁺ cations. The extracts from natural products may preferably be licorice extracts.

The anti-pathogenic agent(s) may be physically coated on the surface of the membrane. The coating may be applied using chemical or electrochemical methods such as atomic layer deposition, vapor deposition methods such as physical vapor deposition (PVD) or chemical vapor deposition (CVD), spray coating methods such as plasma spraying or spray painting, or physical coating methods such dip-coating or spin-coating.

The anti-pathogenic agent(s) may alternatively be incorporated into the membrane by blending the anti-pathogenic agent(s) into the polymer solution prior to electrospinning, thereby generating a membrane impregnated with the anti-pathogenic agent(s).

In some embodiments, the disclosed nanofibrous polymer membrane may be impregnated with one or more metal-organic frameworks (MOFs), such as zirconium MOFs. The MOFs may be incorporated into the membrane by blending the MOFs into the polymer solution prior to electrospinning, thereby generating a membrane impregnated with the MOFs.

In some embodiments, MOF-impregnation into the membrane may be in addition to coating with or impregnation of anti-pathogenic agent(s). In other embodiments, MOF-impregnation into the membrane may be an alternative to coating with or impregnation of anti-pathogenic agent(s). Membranes impregnated with MOFs may provide filtration of chemical warfare agents (CWAs) and other toxic chemical agents. In some embodiments, membranes impregnated with MOFs may also exhibit antiviral, antibacterial, or other anti-pathogenic properties.

Thus, it is not intended that the MOFs described herein are necessarily distinct from the anti-pathogenic agents, such as antiviral or antibacterial agents, described herein. Rather, the anti-pathogenic agent may be a MOF or may alternatively be one of the other anti-pathogenic agents described herein. It is also not intended that the MOFs described herein will necessarily exhibit antiviral, antibacterial, or other anti-pathogenic properties. MOFs that are impregnated in the disclosed membranes may provide filtration of chemical warfare agents (CWAs) and other toxic chemical agents but, in some embodiments, may not exhibit antiviral, antibacterial, or other anti-pathogenic properties or provide filtration of small particulates.

In some embodiments, the disclosed nanofibrous polymer membrane may be impregnated with one or more photocatalysts, such as TiO₂, N-doped TiO₂, Ag-doped TiO₂, or Al₂O₃-TiO₂. The photocatalyst may be incorporated into the membrane by blending the photocatalyst into the polymer solution prior to electrospinning, thereby generating a membrane impregnated with the photocatalyst.

In some embodiments, photocatalyst-impregnation into the membrane may be in addition to coating with or impregnation of anti-pathogenic agent(s). In other embodiments, photocatalyst-impregnation into the membrane may be an alternative to coating with or impregnation of anti-pathogenic agent(s). Membranes impregnated with photocatalysts may facilitate degradation of VOCs. In some embodiments, membranes impregnated with photocatalysts may also exhibit antiviral, antibacterial, or other anti-pathogenic properties.

Thus, it is not intended that the photocatalysts described herein are necessarily distinct from the anti-pathogenic agents, such as antiviral or antibacterial agents, described herein. Rather, the anti-pathogenic agent may be a photocatalyst or may alternatively be one of the other anti-pathogenic agents described herein. It is also not intended that the photocatalysts described herein will necessarily exhibit antiviral, antibacterial, or other anti-pathogenic properties. Photocatalysts that are impregnated in the disclosed membranes may facilitate degradation of VOCs but, in some embodiments, may not exhibit antiviral, antibacterial, or other anti-pathogenic properties.

In some embodiments, the photocatalyst-impregnated nanofibrous polymer membrane may be used in conjunction with a carbon nanofiber (CNF) membrane for removal of CO₂. In some alternate embodiments, the membrane may have one or more photocatalyst-impregnated layers and one or more CNF layers.

The photocatalyst-impregnated membrane preferably exhibits high filtration efficiency, thermal insulation, and photodegradation capability, and allows for efficient VOC degradation and small particle filtration. The use of an additional CNF membrane in the system allows effective in situ CO₂ capture during photocatalytic degradation. The rate of VOC degradation is preferably greater than 95%, and the CO₂ adsorption rate is preferably greater than 20 mmol/m²s.

In some embodiments, a yttria-stabilized zirconia (YSZ) / silica nanofibrous membrane may be additionally or alternatively be used in the applications described herein, particularly in applications that include photocatalytic removal of VOCs.

To increase the breathability of textile materials coated with the disclosed nanofibrous polymer membranes, multiple nanofiber layers of differing thicknesses may be electrospun on the same or opposite sides of textile materials. A textile material that is in the form of a textile material roll may be coated with one or more nanofiber layers by electrospinning. In some embodiments, one or more first nanofiber layers are electrospun on a first side of a textile material at a first winding speed, the textile material roll is flipped, and one or more second nanofiber layers are electrospun on a second side of the textile material at a second winding speed, where the first winding speed is different from the second winding speed. In other embodiments, one or more first nanofiber layers are electrospun on a first side of a textile material at a first winding speed, and one or more second nanofiber layers are then electrospun on the first side of the textile material at a second winding speed, where the first winding speed is different from the second winding speed. In yet other embodiments, one or more first nanofiber layers are electrospun on a first side of a textile material at a first winding speed, one or more second nanofiber layers are then electrospun on the first side of the textile material at a second winding speed, the textile material roll is then flipped, and one or more third nanofiber layers are electrospun on a second side of the textile material at a third winding speed, where the first winding speed is different from the second winding speed. In yet other embodiments, additional electrospinning steps may be added to include additional nanofiber layers of different thicknesses on one or both sides of the textile material.

A facemask or respirator made from the disclosed nanofibrous polymer membrane is also disclosed herein. The facemask or respirator may preferably have a high filtration capacity and suitable breathability characteristics for comfortable use by a wearer. The disclosed facemask or respirator may preferably have a filtering efficiency of at least 95%, more preferably at least 98%, even more preferably at least 99%, and most preferably at least 99.9%.

In some embodiments, a facemask made from the disclosed nanofibrous polymer membrane is a flexible, breathable, and antimicrobial facemask based on an all-nanofiber TENG (NF-TENG) platform. In some embodiments, the facemask comprises multiple layers. In some embodiments, the multilayer facemask includes a tribo-positive layer of polyamide (PA66) nanofibers, a tribo-negative layer of poly (vinylidene fluoride) (PVDF) nanofibers, and a conductive electrode layer with polypyrrole, silver nanowires, or a conductive fabric.

A method of making a facemask or respirator from the disclosed nanofibrous polymer membrane is also disclosed herein. The method may preferably allow the anti-pathogenic, physical, chemical, and mechanical properties to be fine-tuned according to the requirements of the specific application.

A method of making an air filter for use in an HVAC system from the disclosed nanofibrous polymer membrane is also disclosed herein.

A method of making an air filter for use in the removal of VOCs and CO₂ from the disclosed nanofibrous polymer membrane and a carbon nanofiber membrane is also disclosed herein.

### Sample Preparation

The following sample preparation materials and methods are exemplary. Other suitable materials and methods may be used within the scope of the invention.

Materials. Multiple Tecophilic™ thermoplastic polyurethanes (TPU) were purchased from Lubrizol. Knyar 2801 polyvinylidene fluoride (PVDF) was purchased from Arkema. Zytel 7301 polycaprolactam was provided by DuPont. Hexafluoroisopropanol (HFIP) was purchased from Oakwood Products Inc. Dimethylacetamide (DMAc), acetone, formic acid, cetrimonium bromide (CTAB), lithium chloride (LiCl), and tetrabutylammonium chloride (TBAC) were purchased from Fisher Scientific. Silver nanopartcies (15 nm) were purchased from Skyspring Nanomaterials. ZnO and CuO (Zn—Cu) were purchased from Sigma Aldrich. Ag-doped TiO₂ (Ag—TiO₂) nanoparticles were provided by JM Material Technology Inc. Licorice extracts were provided by XSL USA Inc.

Solution Preparation. TPU polymers were added to HFIP to create 7 and 15 w/v solutions. 16.5% wt PVDF was dissolved in 3:1 DMAc/acetone containing 0.85% CTAB and 0.04% LiCl, NaCl, or TBAC. All of the solutions were mixed on a stirring plate until the polymer pellets/powder completely dissolved.

Antiviral Treatment. Two antiviral treatment methods were used: (1) the membranes were submerged in an aqueous dispersion containing antiviral particles, or (2) the antiviral agents were added to the polymer solutions to directly fabricate antiviral nanofibrous membranes. The antiviral agents used were 2% citric acid and silver, Ag—TiO₂ and Zn-Cu nanoparticles, and licorice extracts.

Membrane Fabrication. The membrane fabrication process was a roll-to-roll system, where a textile material was wound from one side to the other side and the nanofiber layer was laminated on the textile during the winding process. The thickness of the nanofiber layers was controlled by controlling the winding speed.

The electrospinning process was performed in a single step or alternatively in at least three separate steps.

In the one-step process, one syringe was filled with a polyvinylacetate (PVAc) solution and one or more additional syringes were filled with the target polymer solution. The PVAc and target polymer solutions were electrospun simultaneously. The layer contacting the substrate was formed of PVAc and thereby provided increased adhesion between the substrate and the nanofibrous membrane layers.

In the three-step process, the substrate was first coated with a cellulose-based adhesive using a sponge coating process. Then electrospun nanofibers were coated onto the substrate. Finally, the coated substrates were dried by heating.

Functionalization. The membrane was functionalized either by adding the desired functionalizing agents to the electrospinning solution or by suspending the electrospun membrane in a dispersion of the desired functionalizing agent in a solvent, such as 2% zirconium MOF, 2% citric acid and silver, Ag—TiO₂, ZnO or CuO nanoparticles, or licorice extract.

Photocatalyst-Impregnated Membrane Preparation. A photocatalyst precursor is prepared with 2.5 mL of a 1-100 mg/mL solution of a photocatalytic material or photocatalytic material precursor selected from the group consisting of titanium tetraisopropoxide, Al(acac)₃, and AgNO₃, 0.3 g of a surfactant selected from the group consisting of polyvinylpyrrolidone (PVP), lauramidopropyl betaine (LAPB), alpha olefin sulfonate (AOS), and cetrimonium bromide (CTAB), 4.5 mL of ethanol, and 3.0 mL of acetic acid. The solution is subsequently stirred on a stirring plate for over 12 h.

Nanofibers carriers for the photocatalyst are fabricated using an electrospinning apparatus. The process parameters used for electrospinning are a flow rate of 0.5 mL/h, a vertical distance from the needle to grounded aluminum foil of 10-15 cm, and an applied voltage of 15-20 kV. The electrospun nanofibers are calcined at 600° C. for 2 h in air, with a ramping rate of 1-3° C./min.

The nanofiber carriers are submerged in the prepared photocatalyst precursor for 5 min under vacuum and then rinsed thrice with 2-propanol. The photocatalyst-impregnated nanofibers are dried overnight under ambient conditions, and are then calcined at 500° C. for 1 h in air, with a ramping rate of 5° C./min.

Carbon Nanofiber Membrane Preparation. A carbon nanofiber membrane is prepared by treating an eletrospun nanofiber mat. The prepared eletrospun nanofiber mat is chemically dehydrofluorinated at 70° C. for 1 h in a 4 M aqueous NaOH solution containing 12.5 mM of tetrabutylammonium bromide (TBAB). After chemical dehydrofluorination is complete, the mat is washed with water and ethanol several times, and is then dried under reduced pressure at 60° C. Finally, the mat is treated by a carbonization process: the mat is heated at a rate of 3° C. /min up to 1000° C. under an argon atmosphere and maintained at this temperature for 1 h.

### Characterization of Representative Samples

To investigate the feasibility of using the disclosed nanofibrous polymer membranes in facemasks and respirators or in HVAC or other air filtration applications, the morphology, fiber diameter, filtering efficiency, porosity, wettability, mechanical strength, and optionally antiviral activity and particulate-retention capacity of representative samples of embodiments of the disclosed nanofibrous polymer membrane were characterized.

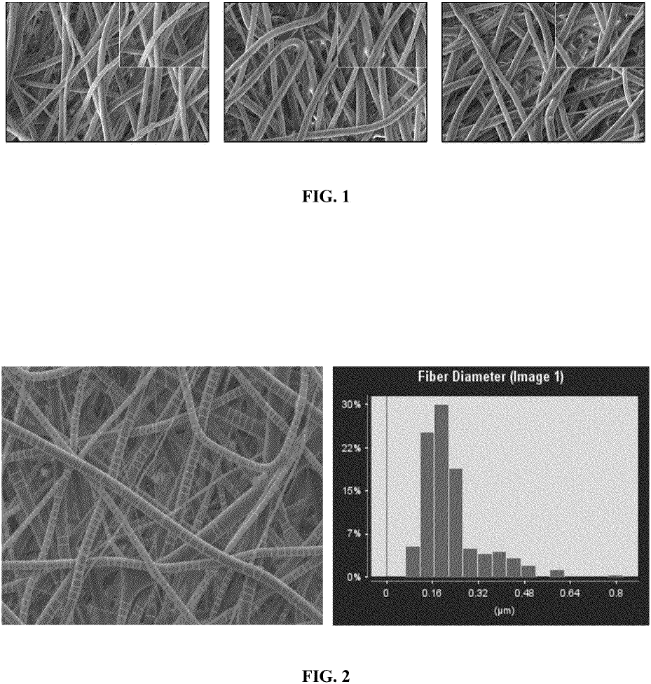

Nanofibrous polymer membranes were characterized using scanning electron microscopy (SEM) imaging. FIG. 1 shows representative SEM images of an embodiment of the disclosed nanofibrous polymer membrane. The larger images show 2000X magnification, while each inset shows the respective 5000X magnification image. As shown in FIG. 1, the internal and external surfaces of each nanofiber membrane display consistent morphology between samples. In addition, the nanofibrous membranes show good orientation and are free of breading, splitting, and other undesirable morphological features.

FIG. 2 shows fiber diameter measurements and distribution for representative samples of an embodiment of the disclosed nanofibrous polymer membrane. The average fiber diameter of representative samples was 0.224 µm, with a median fiber diameter of 0.210 µm and a standard deviation of 0.106. The average orientation was 79 °, and the area coverage was 16%.

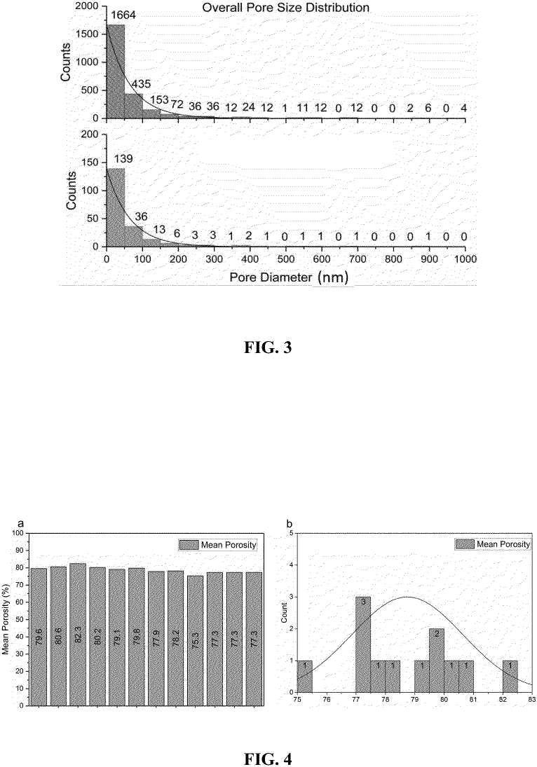

FIG. 3 shows pore size distribution for representative samples of an embodiment of the disclosed nanofibrous polymer membrane as determined by mercury porosimeter analysis. The mean pore diameter was found to be 0.0025 µm.

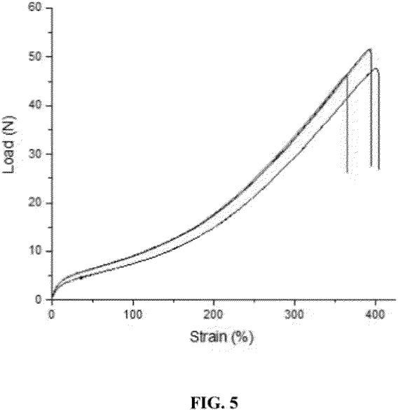

FIG. 4 shows average porosity and the distribution of mean porosity for representative samples of an embodiment of the disclosed nanofibrous polymer membrane. The average porosity as determined by gravimetric measurements was shown to be distributed around a center point of 78.5%. As shown in FIG. 4, all samples showed consistent porosity in the range of 75% to 83%. High porosity of the membrane is a critical requirement to increase the breathability of a facemask or filter made from the membrane.

FIG. 5 shows mechanical tensile strength test results for representative samples of an embodiment of the disclosed nanofibrous polymer membrane.

A representative sample of an embodiment of the disclosed nanofibrous polymer membrane was also tested for filtration efficiency. The observed efficiency was 99.61% for 30 L/min, with a pressure loss of 1.265 mbar, and 99.85% for 95 L/min, with a pressure loss of 4.3 mbar.

Table 1 shows a summary of test results for representative samples of an embodiment of the membrane.

TABLE 1

| | | | |
|---|---|---|---|
| Laboratory | Test | Standard | Results |
| ATI International | Filtration Efficiency | NIOSH | >99% mean filtration efficiency |
| Nelson Labs | Synthetic Blood Penetration | ASTM F2100 | no penetration |
| Nelson Labs | Flammability Test | ASTM F2101 | Class 1 |
| Nelson Labs | Cytotoxicity | ASTM F2102 | Grade 0 |
| Nelson Labs | Particle Filtration Efficiency | ASTM F2103 | average 99% |
| Nelson Labs | Virus Filtration Efficiency | ASTM F2104 | average 99.5% |
| Nelson Labs | Bacterial Filtration Efficiency | ASTM F2105 | average 99.5% |
| MicroChem | MS2 Bacteriophage | AATCC 100 | >99% reduction |
| MicroChem | Human Coronavirus 229E | AATCC 100 | >99.9% reduction |
| Matregenix | E. coli | ASTM E2315 | >99.9% reduction |
| Matregenix | GFP Lentivirus | AATCC 100 | >99.9% reduction |
| Matregenix | Membrane Microstructure | N/A | SEM fiber diameter analysis porosity measurements contact angle measurements |

Representative samples of an embodiment of the membrane did not degrade after washing with water or ethanol. By contrast, a sample of a melt-blown membrane showed a significant decrease in filtration efficiency after washing with ethanol.

A comparison between a representative sample of an embodiment of the disclosed nanofibrous polymer membrane and a typical melt-blown membrane is shown in Table 2.

TABLE 2

| Parameter | Melt-Blown Membrane | Nanofiber Membrane |
|---|---|---|
| Thickness (gsm) | 35 | 0.8 |
| Fiber Diameter (µm) | 10 | 0.15 |
| Pore Size | 6 | 0.05 |
| Filtration Efficiency (%) | 95 | 99 |
| Post-Washing Filtration Efficiency (%) | 62 | 99 |
| Water Vapor Transmission Rate (WVTR) | 142 | 155 |
| Water Contact Angle (°) | 119 | 153 |
| Cytocompatibility (%) | 105 | 155 |

The filtration efficiency and observed pressure drop for various membrane samples for use in personal protective equipment applications is shown in Table 3.

TABLE 3

| Sample No. | Flow Rate (L/min) | Filtration Efficiency (%) | Pressure Drop (mm wg ) |
|---|---|---|---|
| QF-117 | 85 | 97.10 | 13.8 |
| QF-104 | 85 | 99.58 | 20.8 |
| QF-105 | 85 | 99.02 | 18.7 |
| QF-108 | 85 | 99.49 | 18.9 |
| MXF011 | 20 | 98.17 | 3.0 |
| MXF011 | 32 | 98.10 | 4.6 |
| MXF011 | 60 | 98.46 | 8.8 |
| MXF011 | 80 | 97.16 | 11.8 |
| MXF011 | 100 | 97.65 | 16.7 |
| MXF012 | 20 | 98.57 | 2.9 |
| MXF012 | 32 | 97.76 | 4.4 |
| MXF012 | 60 | 97.65 | 8.9 |
| MXF012 | 80 | 97.89 | 12.2 |
| MXF012 | 100 | 98.18 | 16.6 |
| MXF013 | 20 | 95.61 | 2.4 |
| MXF013 | 32 | 96.22 | 4.0 |
| MXF013 | 60 | 95.98 | 8.6 |
| MXF013 | 80 | 97.62 | 11.8 |
| MXF013 | 100 | 96.99 | 15.6 |

The filtration efficiency and observed pressure drop for various membrane samples for use in HVAC applications is shown in Table 4.

TABLE 4

| Sample No. | Flow Rate (L/min) | Substrate | Filtration Efficiency (%) | Pressure Drop (mm wg) | Filtration Efficiency (%) | Pressure Drop (mm wg) |
|---|---|---|---|---|---|---|
| QFM-080 | 32.5 | 978/100 | 20 | 0.2 | 70 | 0.40 |
| QFM-081 | 32.5 | 978/100 | 20 | 0.2 | 66 | 0.30 |
| QFM-084 | 32.5 | 778/70G | 20 | 0.2 | 77 | 0.50 |
| QFM-085 | 32.5 | 778/70G | 20 | 0.2 | 72 | 0.35 |

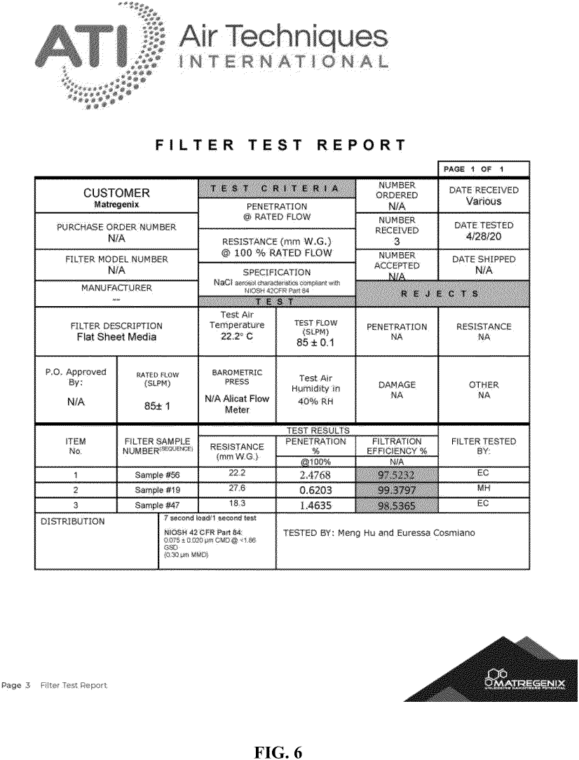

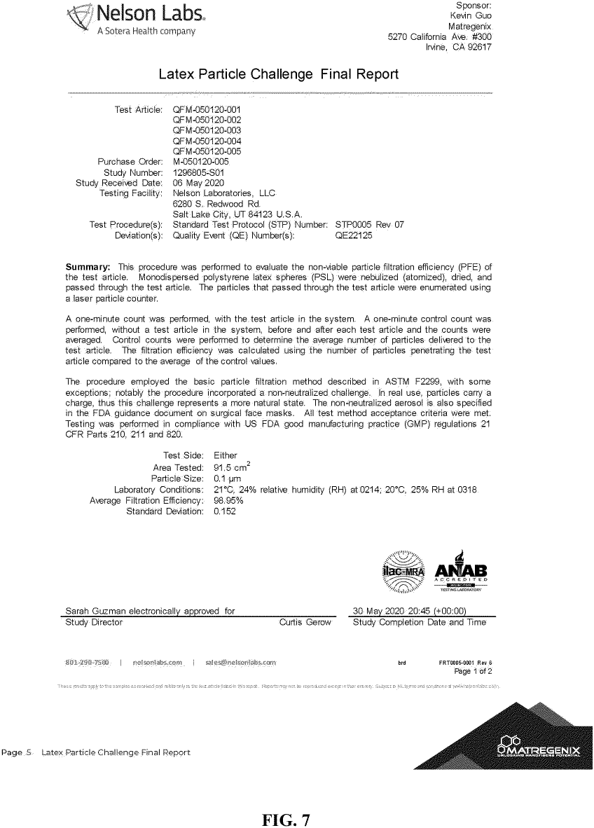

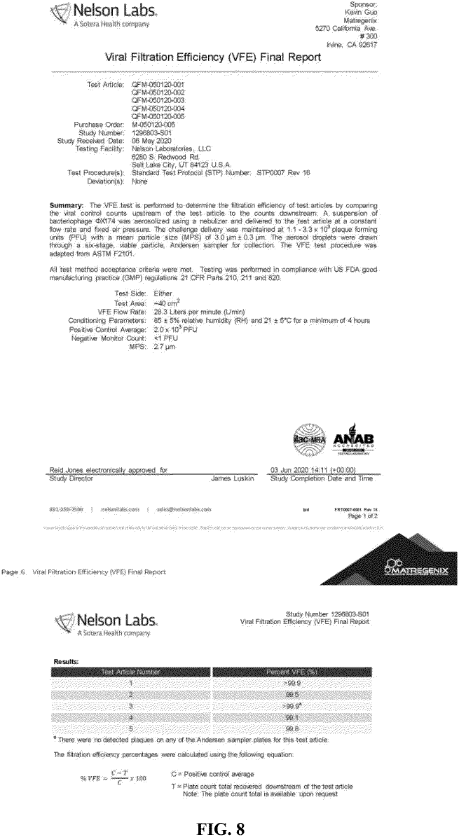

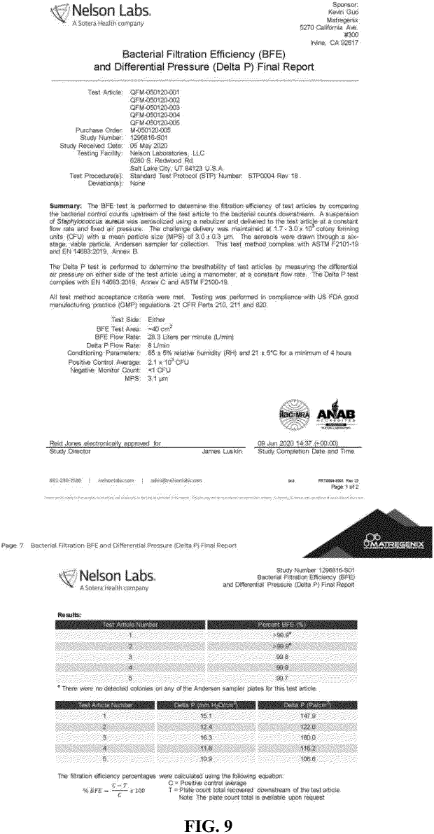

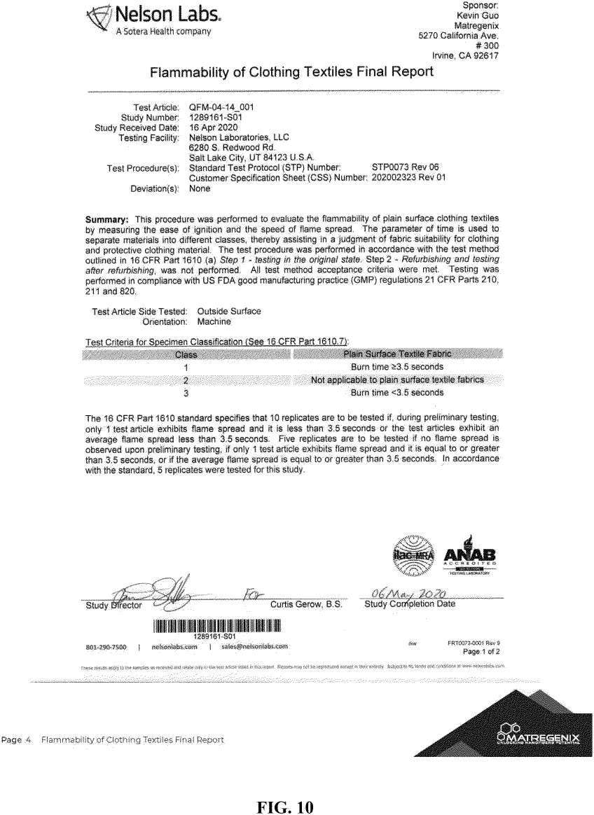

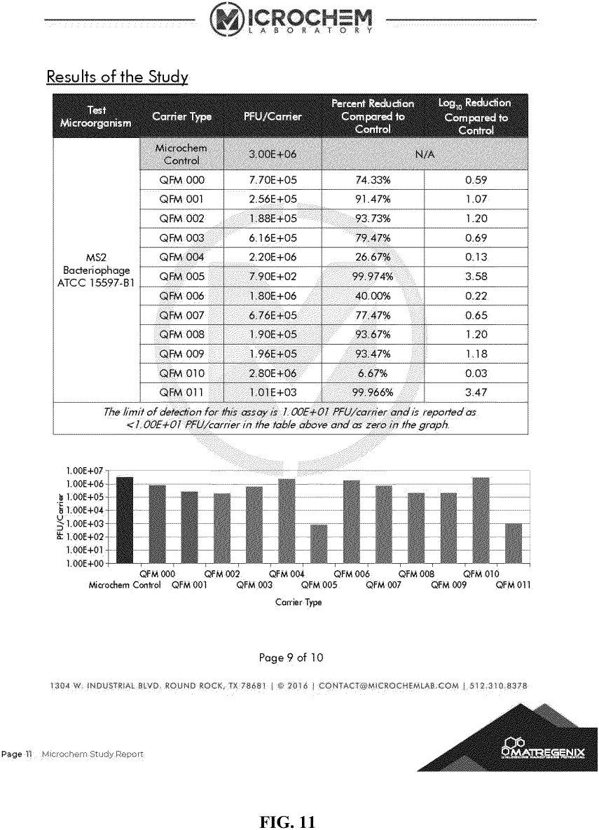

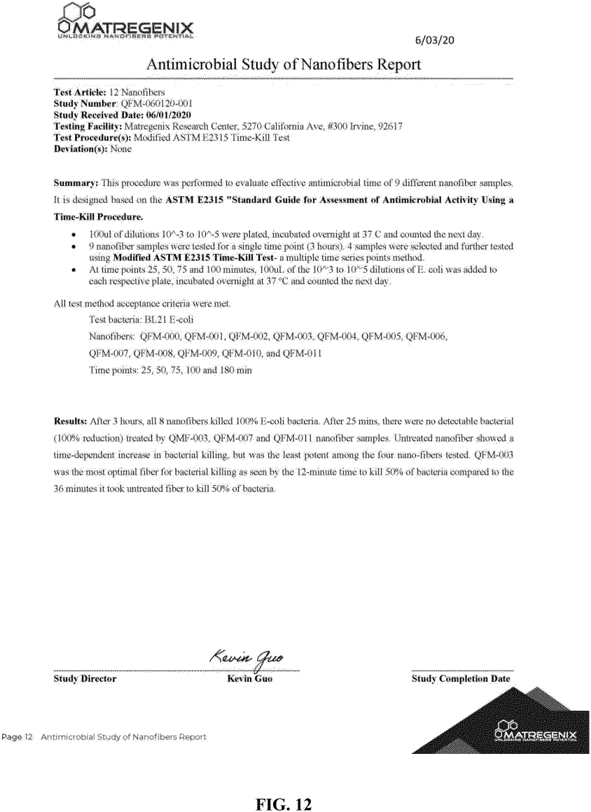

FIGS. 6-12 show test results for filtration efficiency, flammability, and antiviral and antimicrobial properties for representative samples of an embodiment of the disclosed nanofibrous polymer membrane intended for use in personal protective equipment applications.

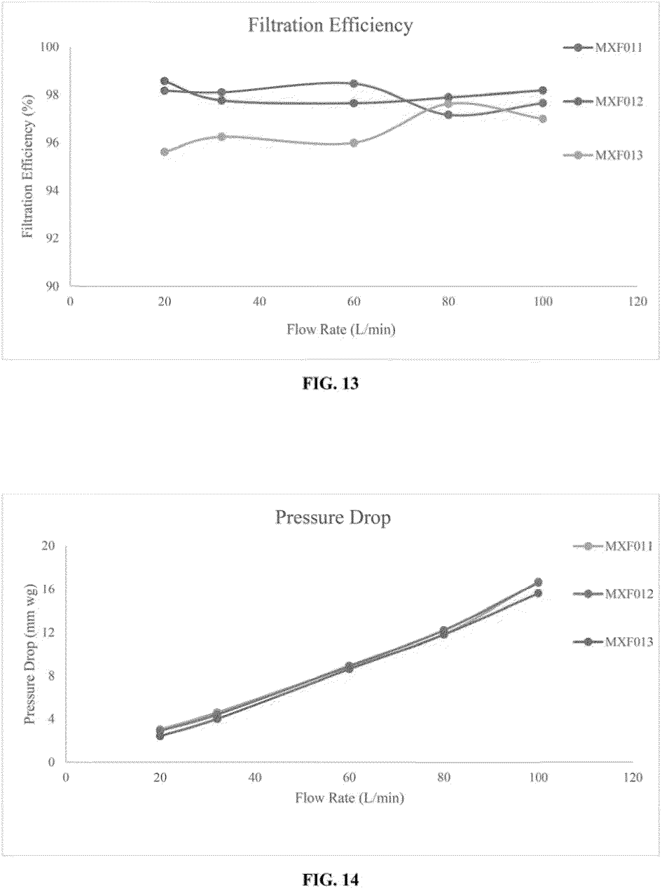

FIG. 13 shows how filtration efficiency is affected by the flow rate of aerosols through the membrane.

FIG. 14 shows how the pressure drop across the membrane, which is a measure of breathability of the membrane, is affected by the flow rate of aerosols through the membrane.

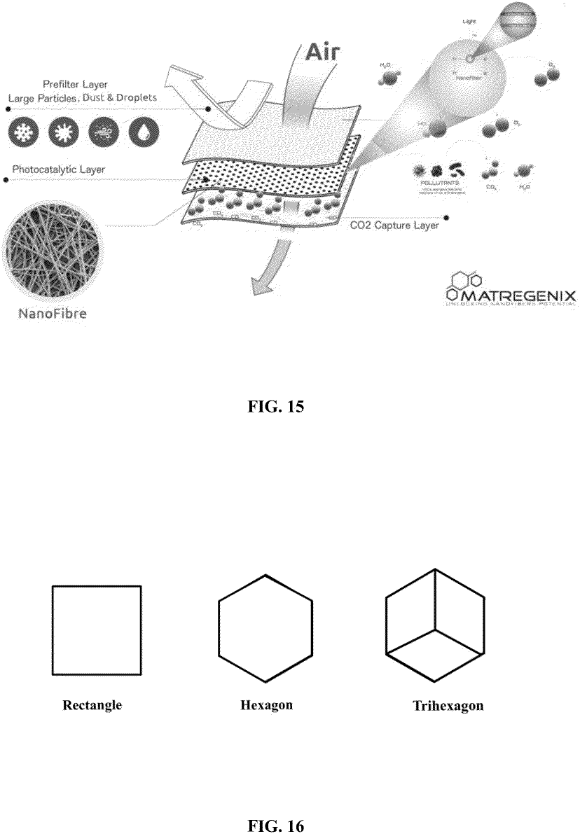

FIG. 15 shows an embodiment of a system for removing volatile organic compounds and carbon dioxide that is composed of a photocatalyst-impregnated nanofibrous polymer membrane and a carbon nanofiber membrane.

FIG. 16 shows the basic repeat units of rectangular, hexagonal, and trihexagonal opening patterns for mesh substrates.

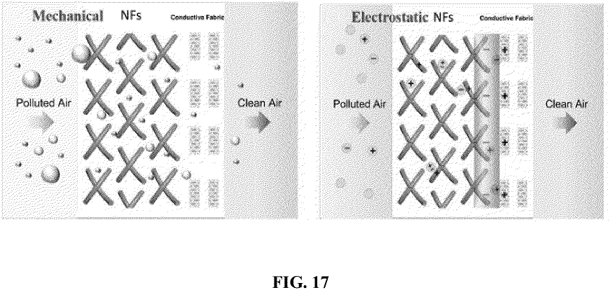

FIG. 17 shows a schematic representation of a flexible, breathable, and antimicrobial facemask based on an all-nanofiber TENG (NF-TENG) platform.

The previous description of the disclosed embodiments is provided to enable any person skilled in the art to make or use the invention disclosed herein. Although the various inventive aspects are disclosed in the context of one or more illustrated embodiments, implementations, and examples, it should be understood by those skilled in the art that the invention extends beyond the specifically disclosed embodiments to other alternative embodiments and/or uses of the invention and obvious modifications and equivalents thereof. It should be also understood that the scope of this disclosure includes the various combinations or sub-combinations of the specific features and aspects of the embodiments disclosed herein, such that the various features, modes of implementation, and aspects of the disclosed subject matter may be combined with or substituted for one another. The generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

All references cited are hereby expressly incorporated herein by reference.

What is claimed is:

1. An electrospun polymer nanofibrous membrane having a high filtration efficiency comprising polyvinylidene fluoride, one or more Tecophilic™ thermoplastic polyurethanes, or a blend of polyvinylidene fluoride and one or more Tecophilic™ thermoplastic polyurethanes, wherein the membrane is treated with one or more anti-pathogenic agents.

2. The membrane of claim 1, wherein the one or more anti-pathogenic agents comprise an antiviral agent.

3. The membrane of claim 2, wherein the antiviral agent is selected from the group consisting of graphene, nanoparticles, nanocomposites, multivalent metallic ions, and extracts from natural products.

4. The membrane of claim 3, wherein the antiviral agent comprises a silver-doped titanium dioxide nanomaterial.

5. The membrane of claim 3, wherein the antiviral agent comprises multivalent Cu²⁺ or Zn²⁺ cations.

6. The membrane of claim 3, wherein the antiviral agent comprises a licorice extract.

7. The membrane of claim 1, wherein the membrane is electrospun from a polymer solution that includes a surfactant selected from the group consisting of cetrimonium bromide (CTAB), lauramidopropyl betaine (LAPB), and alpha olefin sulfonate (AOS).

8. The membrane of claim 2, wherein the membrane comprises multiple integrated layers with distinguishable microstructure characteristics.

9. The membrane of claim 8, wherein the membrane is composed of three layers including a first and third layer having equal pore size separated by a second layer having a different pore size.

10. The membrane of claim 8, wherein the membrane is composed of three layers with three different pore sizes.

11. The membrane of claim 9, wherein the first and third layers have a larger pore size and the second layer has a smaller pore size, and wherein the mechanical integrity and binding forces between layers of the membrane is enhanced by electrospraying short fibers prior to electrospinning a subsequent layer of the membrane or by electrospinning wet fibers by decreasing the screen distance to generate a “tacky surface” prior to electrospinning a subsequent layer of the membrane.

12. The membrane of claim 8, wherein the membrane is formed by winding a textile material roll comprising a textile material from a first side to a second side and then performing the following steps in order:
a. electrospinning one or more first nanofiber layers on the first side of the textile material at a first winding speed;
b. flipping the textile material roll; and
c. electrospinning one or more second nanofiber layers on the second side of the textile material at a second winding speed;
wherein the first winding speed is different from the second winding speed.

13. The membrane of claim 8, wherein the membrane is formed by winding a textile material roll comprising a textile material from a first side to a second side and then performing the following steps in order:
a. electrospinning one or more first nanofiber layers on the first side of the textile material at a first winding speed; and
b. electrospinning one or more second nanofiber layers on the first side of the textile material at a second winding speed;
wherein the first winding speed is different from the second winding speed.

14. The membrane of claim 8, wherein the membrane is formed by winding a textile material roll comprising a textile material from a first side to a second side and then performing the following steps in order:
a. electrospinning one or more first nanofiber layers on the first side of the textile material at a first winding speed;
b. electrospinning one or more second nanofiber layers on the first side of the textile material at a second winding speed;
c. flipping the textile material roll; and
d. electrospinning one or more third nanofiber layers on the second side of the textile material at a third winding speed;
wherein the first winding speed is different from the second winding speed.

15. The membrane of claim 1, wherein the membrane is triboelectrically charged using a triboelectric nanogenerator (TENG).

16. The membrane of claim 15, wherein the membrane comprises three layers, including a tribo-positive layer of polyamide (PA66) nanofibers, a tribo-negative layer of poly (vinylidene fluoride) (PVDF) nanofibers, and a conductive electrode layer with polypyrrole, silver nanowires, or a conductive fabric.

17. The membrane of claim 1, wherein the membrane is suitable for use in a facemask or respirator.

18. The membrane of claim 1, wherein the membrane is suitable for use in an air filter configured for use in an HVAC system or for use in an air filter configured for use in the removal of VOCs and CO₂ in conjunction with a carbon nanofiber membrane.

19. An electrospun polymer nanofibrous membrane having a high filtration efficiency comprising polyvinylidene fluoride, one or more Tecophilic™ thermoplastic polyurethanes, or a blend of polyvinylidene fluoride and one or more Tecophilic™ thermoplastic polyurethanes, wherein one or more anti-pathogenic agents is impregnated into the membrane, wherein the membrane comprises multiple integrated layers with distinguishable microstructure characteristics.

20. The membrane of claim 19, wherein the membrane is composed of three layers including a first and third layer having equal pore size separated by a second layer having a different pore size, wherein the first and third layers have a larger pore size and the second layer has a smaller pore size, and wherein the mechanical integrity and binding forces between layers of the membrane is enhanced by electrospraying short fibers prior to electrospinning a subsequent layer of the membrane or by electrospinning wet fibers by decreasing the screen distance to generate a “tacky surface” prior to electrospinning a subsequent layer of the membrane.
